(19) United States
(12) Patent Application Publication
(10) Pub. No.: US 2018/0139338 A1
(43) Pub. Date: May 17, 2018

(54) DEVICE FOR ENHANCED READING

(71) Applicant: AVANT-GOUT STUDIOS, Saint Etienne (FR)

(72) Inventor: Adrien PIFFARETTI, La Tour En Jarez (FR)

(21) Appl. No.: 15/571,489

(22) PCT Filed: May 3, 2016
(86) PCT No.: PCT/FR2016/051042

§ 371 Date: Nov. 2, 2017

(30) Foreign Application Priority Data
May 4, 2015 (FR) 15/53982

(51) Int. Cl. H04N 1/00; H04N 1/028

(52) U.S. Cl. CPC H04N 1/00562; H04N 2201/0084; H04N 1/02885

(57) ABSTRACT

A device including a stand portion for holding a user terminal having a camera, and a reflective element for reflecting an image of a visual information medium toward the camera of the user terminal, the reflective element is connected to the stand portion by a pre-positioning member movably mounted in relation to the stand portion. And the pre-positioning member is designed to bear against a surface of the user terminal with a view to pre-positioning the reflective element in relation to the camera of the user terminal.

### TECHNICAL FIELD

The present invention concerns an enhanced reading device.

### BACKGROUND

It is known to enrich a book reading experience by means of enhanced reading.

The enhanced reading consists in broadcasting multimedia information, for example a sound, an image, a video or a video game, in connection with the content of the book being read.

However, the conventional enhanced reading devices may be bulky. Hence, there is a need for miniaturizing of these devices, allowing facilitating their use and their mobility.

Furthermore, the existing reading devices may have difficulties in the acquisition of images of the medium being read, in particular if the relative positioning between the medium and the images acquisition means of the enhanced reading device is inaccurate.

### BRIEF SUMMARY

The disclosure aims at overcoming these drawbacks by proposing an enhanced reading device offering an improved compactness and guaranteeing proper relative positioning with respect to the visual information medium whose reading should be enriched.

To this end, an enhanced reading device is provided, comprising a support portion intended to support a user terminal having a camera, and a reflective element intended to reflect an image of a visual information support in the direction of the camera of the user terminal, in which the reflective element is linked to the support portion via a pre-positioning member movably mounted relative to the support portion, the pre-positioning member being intended to bear against a face of the user terminal in order to pre-position the reflective element with respect to the camera of the user terminal.

Thus, the enhanced reading device according to the invention has the advantage of being barely bulky and of ensuring an accurate capture of images via the camera of the user terminal.

The reflective element is a compact, and energy-efficient, passive means for capturing an image and directing it towards the camera of the user terminal.

The pre-positioning member ensures a proper positioning of the reflective element with respect to the camera of the user terminal.

In addition, the mobility of the pre-positioning member relative to the support portion allows folding over the pre-positioning member and the support portion against each other to have a compact enhanced reading device when this enhanced reading device is stored and not used.

According to a preferred embodiment, the device comprises a holding unit configured to hold the pre-positioning member bearing against the user terminal.

This feature allows immobilizing the pre-positioning member with respect to the user terminal during usage, and this by immobilizing the reflective element with respect to the camera of the user terminal, such that the captured element is stable and accurate.

According to a preferred embodiment, the support portion comprises a support wall having at least two substantially parallel folding lines dividing the support wall into several sections, so that the support wall is deformable by folding between a storage position in which the sections are substantially coplanar and a use position in which the sections form a support for the user terminal.

Thus, the support portion has the advantage of being barely bulky in the storage position, and of being capable of being folded over parallel to the pre-positioning member when the enhanced reading device is stored and not used.

According to a preferred embodiment, the reflective element is movably mounted relative to the pre-positioning member between a storage position in which the reflective element is positioned substantially parallel to the pre-positioning member and a deployed position in which the reflective element is inclined with respect to the pre-positioning member.

This feature has also the advantage of an improved compactness of the enhanced reading device when said enhanced reading device is not used and stored, the reflective element in the storage position and the pre-positioning member then being substantially coplanar.

According to a preferred embodiment, the reflective element comprises a central reflective face and two lateral walls movable relative to the central reflective face between a storage position in which the lateral walls and the central face are substantially parallel and a deployed position in which the lateral walls are inclined with respect to the central reflective face.

The lateral walls improve the quality of the image reflected in the direction of the camera of the user terminal, by limiting the exposure of the reflective element and of this camera to direct light. In particular, this avoids a backlight effect.

According to a preferred embodiment, the device comprises a holding unit configured to hold the reflective element in the deployed position.

This feature contributes to improve the accuracy and the stability of the image perceived and reflected by the reflective element to the camera of the user terminal.

According to a preferred embodiment, the device comprises a base wall movably mounted relative to the support portion or to the pre-positioning member, the base wall being configured to delimit with the pre-positioning member, and where appropriate the support portion, a storage volume intended to receive a visual information medium.

Thus, the enhanced reading device offers the advantageous possibility of allowing the storage, in a barely bulky manner, of the visual information medium between two uses of the enhanced reading device with this visual information medium. This improves the ergonomics of use of the enhanced reading device.

According to a preferred embodiment, the base wall comprises a border delimiting an area for capturing images by the reflective element when the reflective element is in the deployed position.

Thus, the base wall advantageously materializes the area covered by the reflective element, which allows a user to properly position the visual information medium that he wishes to enrich the reading thereof with respect to the enhanced reading device.

According to a preferred embodiment, the support portion, the pre-positioning member, and where appropriate the base wall, are made in one-piece part.

Thus, the enhanced reading device comprises a limited number of components, which reduces its bulk, and its mass, thereby offering improved ergonomics to the user. This also reduces the cost of the enhanced reading device.

According to another aspect, the invention also concerns an enhanced reading set comprising the enhanced reading device having the aforementioned features and comprising the user terminal and/or the visual information medium.

The user terminal may be placed between the support portion in the storage position and the pre-positioning member. The visual information medium may be placed between the base wall and the pre-positioning member. Thus, this allows providing the user with a complete, compact, and mobile enhanced reading solution.

### BRIEF DESCRIPTION OF THE DRAWINGS

Other features and advantages of the present invention will emerge clearly from the detailed description hereinafter of an embodiment, given as a non-limiting example, with reference to the appended drawings in which:

FIG. 1 is a perspective view of an enhanced reading device according to an embodiment of the invention, in the use position,

FIG. 2 is a scaled front view, respectively to the left of a user terminal and to the right of an enhanced reading device according to an embodiment of the invention in the storage position,

FIG. 3 is a front view of an enhanced reading device according to an embodiment of the invention, in an intermediate position comprised between the storage position and the use position,

FIG. 4 is a side view of an enhanced reading device according to an embodiment of the invention, in the use position,

FIGS. 5 to 11 are perspective views of an enhanced reading device according to an embodiment of the invention, illustrating successive steps of the passage of the enhanced reading device from a storage position to a use position.

### DETAILED DESCRIPTION

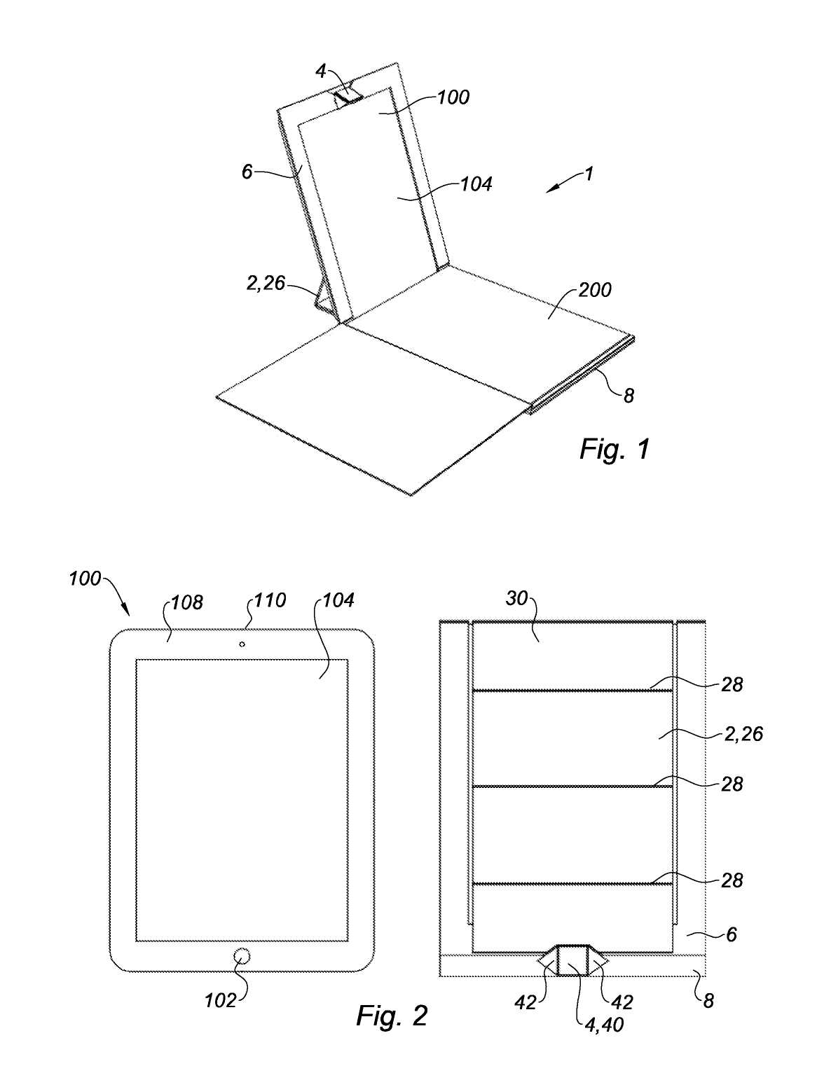

FIG. 1 shows an enhanced reading device 1 according to an embodiment of the invention. The device 1 is intended to transmit, to the camera 102 of a user terminal 100, an image of a visual information medium 200.

The visual information medium 200 may be a paper book or an electronic book, an image, a photograph, a stamp, a parchment, a registration plate, a CD cover, a card game, etc.

Advantageously, the user terminal 100 is a tactile tablet, for example of the iPad or iPad Air type of the Apple brand, or possibly a mobile phone. Hence, the terminal 100 may advantageously be of the type comprising a battery and having a substantially parallelepipedic shape.

The user terminal 100 comprises a display unit, such as a screen 102, to display an image, picture, animation, video or interaction, a video game, and/or an element for emitting a sound, such as a loudspeaker. The screen 102 may be tactile, to form a user interface.

The user terminal 100 may further include a program, or application, allowing broadcasting a multimedia content in connection with the image(s) of the visual information medium 200 transmitted by the device 1 and acquired by the camera 102. The broadcasted multimedia content may be an image, a picture, a video, an animation, an interaction or a video game broadcasted on a screen 104 of the user terminal 100 or a sound.

The visual information medium 200 is placed aside the user terminal 100, for example in front of the screen 102.

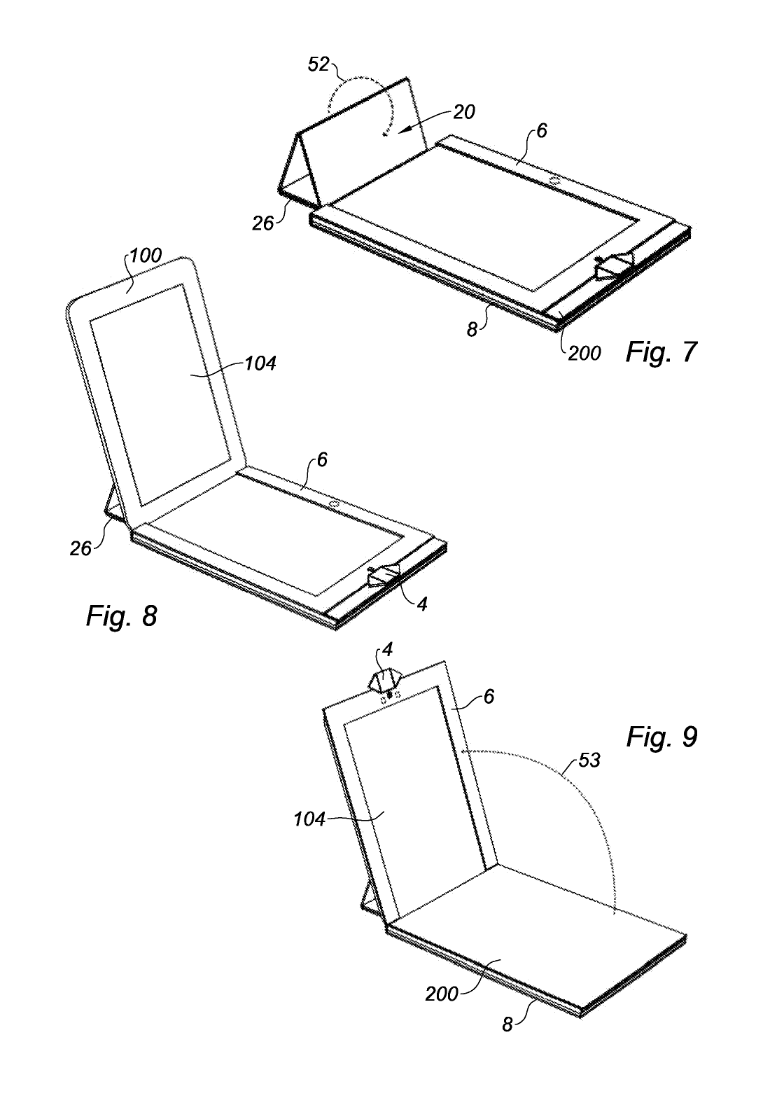

The enhanced reading device 1 comprises a support portion 2. The support portion 2 is intended to support the user terminal 100, as illustrated in FIG. 4.

As illustrated for example in this FIG. 4, the support portion 2 may include a supporting face 20 intended to bear against a back face 106 of the user terminal 100, preferably a blocking flange 22 against which a front face 108 opposite to the back face 106 of the user terminal 100 is intended to bear, in order to block the user terminal 100 and prevent said user terminal from slipping forwards and separating from the supporting face 20, in particular under the effect of gravity, and possibly a bottom wall 24 on which a transverse ridge or edge 110 of the user terminal 100 is intended to rest.

The bottom wall 24 may have a thickness substantially similar to the thickness of the user terminal 100.

During usage, the supporting face 20 is preferably inclined with respect to the bottom wall 24 by an angle comprised between 90° and 135°, and more specifically an angle comprised between 100 and 120°, for example in the range of 110°.

For example, the blocking flange 24 extends in a substantially perpendicular manner to the bottom wall 24.

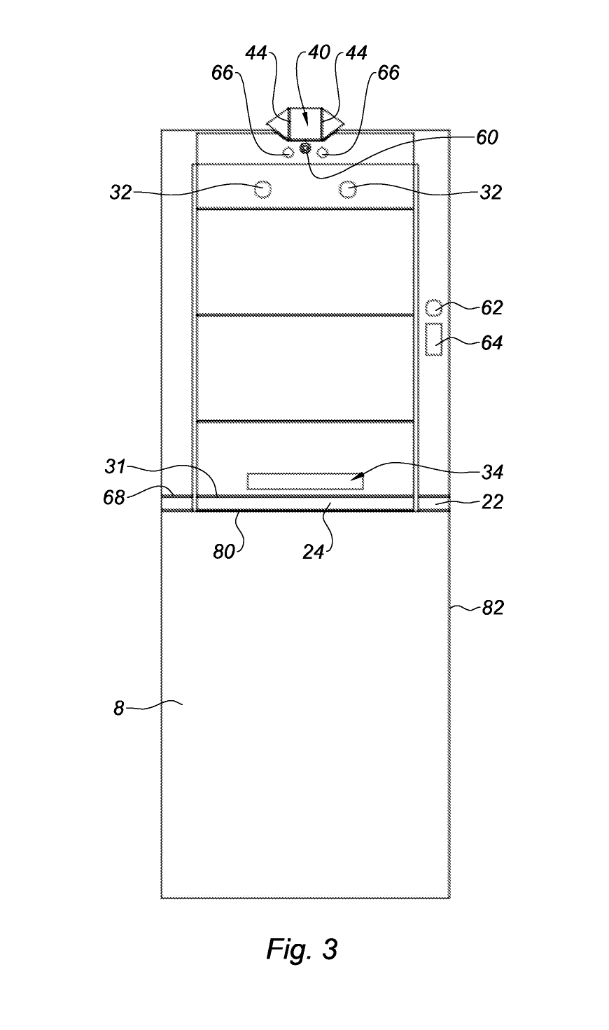

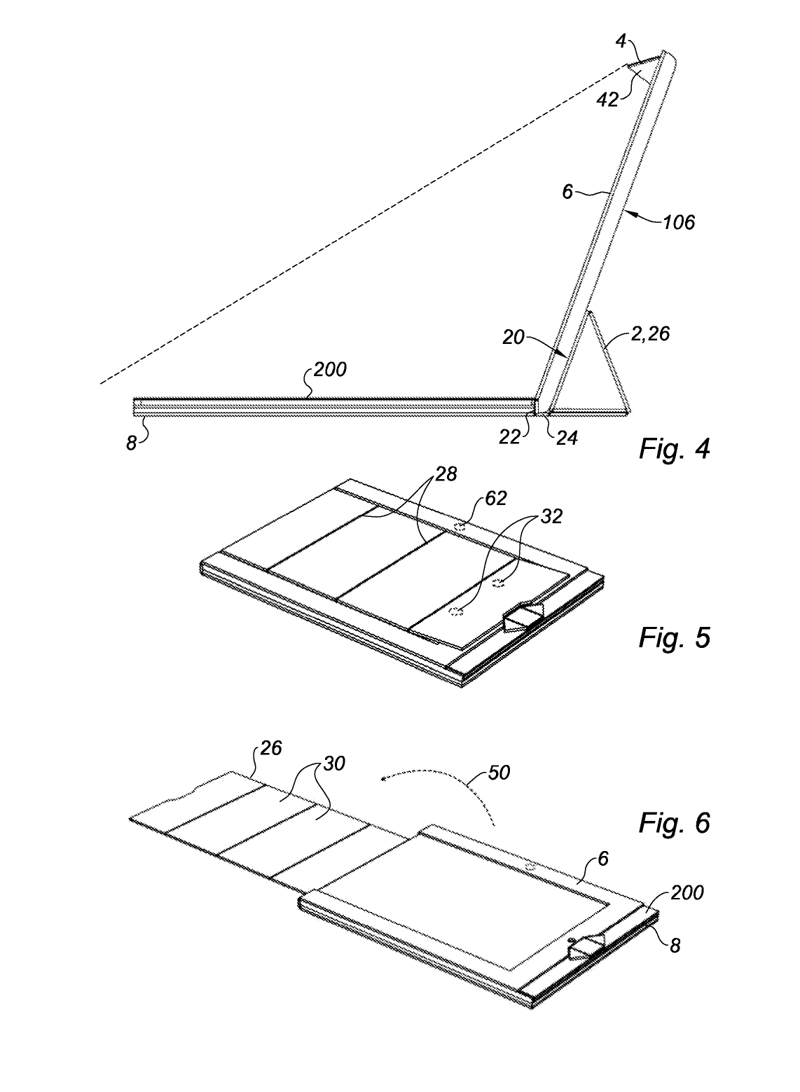

The enhanced reading device 1 also comprises a reflective element 4, shown more particularly in FIG. 2 or 3. During usage, the reflective element 4 is intended to reflect an image of the visual information medium 200 in the direction of the camera 102 of the user terminal 100.

The reflective element 4 may comprise a mirror, in particular a self-adhesive mirror, having a reflective face 40 and an opposite fastening face.

The enhanced reading device 1 also comprises a pre-positioning member or frame 6, herein extending in a substantially planar manner.

The pre-positioning member 6 is intended to be pressed against the front face 108 of the user terminal 100, as shown in FIG. 1. Thus, during usage, the user terminal 100 is interposed between the supporting face 20 and the pre-positioning member 6 which extend in a substantially parallel manner.

Advantageously, the pre-positioning member 6 delimits an opening, open or closed, allowing visualizing the screen 104 of the user terminal 100 while the pre-positioning member 6 bears on the user terminal 100.

The pre-positioning member 6 supports the reflective element 4, herein on a face of the pre-positioning member 6 opposite to the face of the pre-positioning member 6 bearing against the user terminal 100. The reflective element 4 is fastened to the pre-positioning member 6 via its fastening face.

The pre-positioning member 6 may have an opening 60 intended to face the camera 102 when the pre-positioning member 6 bears against the user terminal 100.

The pre-positioning member 6, more specifically an edge of the pre-positioning member 6, is linked to the support portion 2, and more particularly to the blocking flange 22, so that the pre-positioning member 6 is movable in rotation relative to the support portion 2. Preferably, the pre-positioning member 6 is linked to the support portion 2 by a folding line 68.

The reflective element 4 is arranged on the pre-positioning member 6 so as to face the camera 102 when the pre-positioning member 6 bears against the user terminal 100.

It should be noted that the enhanced reading device 1 advantageously comprises a holding unit configured to hold the pre-positioning member 6 bearing against the user terminal 100. For example, this holding unit comprises one or several magnet(s) 62 or metallic element(s) 64, shown in FIG. 3, intended to cooperate with magnets or metallic elements of the user terminal 100 to press the pre-positioning member 6 against said user terminal.

Advantageously, the reflective element 4 is movably mounted, for example in rotation, relative to the pre-positioning member 6, between a storage position, represented in FIGS. 2, 3 and 5 to 9, in which the reflective element 4 is folded over in a substantially parallel manner to the pre-positioning member 6, and a deployed position, represented in FIGS. 1, 4 and 11, in which the reflective element 4 is inclined with respect to the pre-positioning member 6, by a predetermined angle preferably comprised between 45° and 65°, and more specifically in the range of 55°.

As shown for example in FIG. 3, the reflective element 4 advantageously comprises a central reflective face 40, and two lateral walls 42, on either side of the reflective face 40. During usage, the lateral walls 42 are intended to avoid an exposure of the reflective face 40 and of the camera 102 to a direct light to avoid a backlight effect.

Preferably, the lateral walls 42 are movable for example in rotation relative to the central reflective face 40, between a storage position (FIGS. 2, 3 and 5 to 9) in which the lateral walls 42 and the central reflective face 40 are substantially coplanar, and a deployed position (FIGS. 1, 4, 10 and 11), in which the lateral walls 42 are inclined with respect to the central reflective face 40. More particularly, in the deployed position, the lateral walls 42 may be substantially perpendicular to the central reflective face 40.

It should be noted that, in the deployed position of the reflective element 4, the lateral walls 42 may bear against the pre-positioning member 6, as shown for example in FIG. 11.

Preferably, the lateral walls 42 are movable by folding relative to the central reflective face 40. Thus, the reflective element 4 may have two folding lines 44, each folding line 44 separating the central reflective face 40 of one of the two lateral walls 42.

Advantageously, the enhanced reading device 1 comprises a holding unit configured to hold the reflective element 4 in the deployed position. This holding unit may comprise magnets 66, for example arranged in the pre-positioning member 6, the lateral walls 42 may besides be metallic at least partially.

According to an advantageous possibility, the support portion 2 comprises a support wall 26, herein extending from the bottom wall 24, this support wall 26 having in the direction of its width a plurality of substantially parallel folding lines 28, dividing the support wall 26 into a plurality of successive support sections 30 (four according to the example of FIGS. 1 to 11), extending lengthwise parallel to each other.

The supporting face 20 is a face of one of the support sections 30.

One of the sections 30 is directly linked to the bottom wall 24, in this case by a folding line 31 allowing pivoting this section 30 relative to the bottom wall 24.

Because of the folding lines 28, each section 30 is movable in rotation relative to the adjacent section(s) 30.

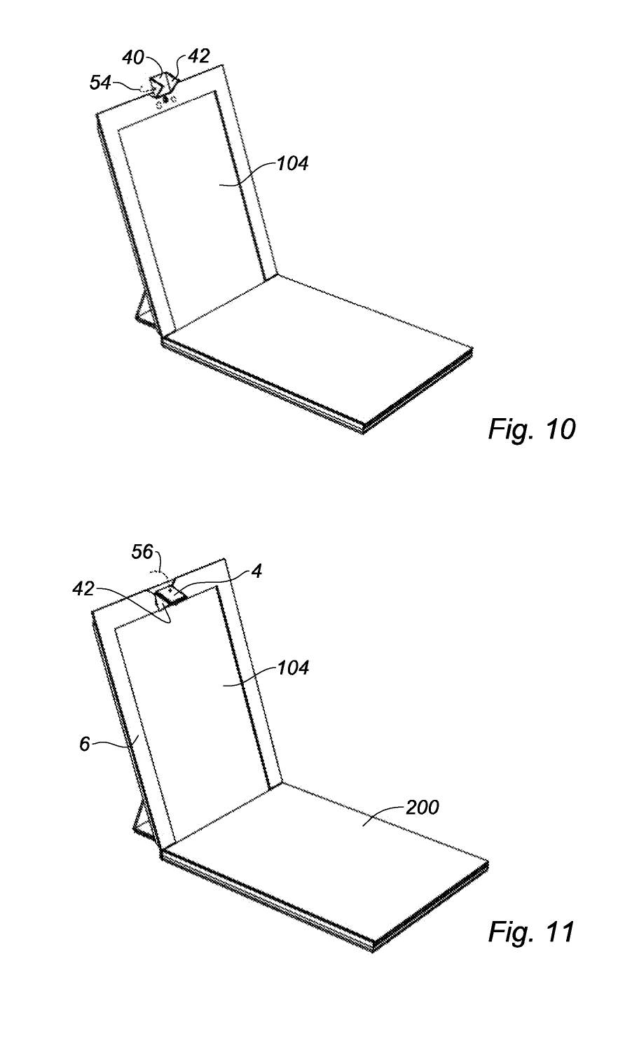

Thus, it is possible to impart different possible shapes to the support wall 26. In particular, the support wall 26 may be extended in a plane, that is to say that the sections 30 may be positioned in a coplanar manner, in order to confer to the support wall 26 a barely bulky storage position, in which the support wall 26 may be folded over against or parallel to the pre-positioning member 6 (FIGS. 2 and 5). It is also possible to fold up the sections 30 by inclining them relative to each other, in order to confer to the support wall 26 a prismatic shape, in particular a triangular prism shape (FIG. 1, 7), corresponding to a use position enabling the support wall 26 to support the user terminal 100.

Advantageously, the enhanced reading device 1 may comprise a holding unit configured to hold the support wall 26 in its use position. Thus, this holding unit comprises for example one or several magnet(s) 32 and one or several metallic element(s) 34. The magnet(s) may be arranged in or on a section 30 intended to bear on another section 30 containing the metallic element(s) when the support wall 26 is in the use position.

As represented in FIGS. 3 and 4, the enhanced reading device 1 may further comprise a base wall 8 configured to delimit with the pre-positioning member 6, and where appropriate the support portion 2, a storage volume intended to receive the visual information medium 200. In the storage position, the visual information medium 200 is interposed between the pre-positioning member 6 and the base wall 8. During usage, the visual information medium 200 is set on the base wall 8, and said base walls extends in an area covered by the reflective element 4 when the pre-positioning member 6 is against the user terminal 100 and the reflective element 4 is in the deployed position, and in particular in front of the screen 102.

The base wall 8 is movably mounted for example in rotation relative to the support portion 2 or to the pre-positioning member 6. According to the example of FIGS. 1 to 11, the base wall 8 is linked to the support portion 2, and more particularly to the bottom wall 24, by a folding line 80, and to the holding flange 22.

The base wall 8 comprises a border 82 delimiting an area for capturing image by the reflective element 4 when the reflective element 4 is in the deployed position and the pre-positioning member 6 bears against the user terminal 100.

It should be noted that the support portion 2, the pre-positioning member 6 and the base wall 8 may belong to one-piece part, that is to say be integral into one-piece part, the movability between the elements being ensured by folding. Thus, the support portion 2, the pre-positioning member 6 and the base wall 8 forming a whole. For example, the support portion 2, the pre-positioning member 6 and the base wall 8 may be made of a cardboard, for example grooved, with a printed adhesive flocking.

The pre-positioning member 6 and the base wall 8 are linked to the support portion 2 at one of their edges, such that the pre-positioning member 6, the support portion 2 and the base wall 8 may be folded over against each other in a compact manner when the enhanced reading device 1 is stored (FIG. 2).

The holding flange 22 may link the base wall 8 and the pre-positioning member 6 in order to serve as a spacer and accordingly contribute to delimit a storage volume of the visual information medium 200 between the base wall 8 and the pre-positioning member 6.

The bottom wall 24 may link the support wall 26 and the base wall 8. The invention also concerns an enhanced reading set comprising the enhanced reading device 1 having all or part of the previously described features and comprising the user terminal 100 and/or the visual information medium 200. FIG. 5 shows the enhanced reading device 1 in the storage position: the support portion 2 rests on the pre-positioning member 6, and the pre-positioning member 6 rests on the base wall 8. The reflective element 4 extends parallel to the pre-positioning member 6.

In order to use the enhanced reading device 1, the user starts by spacing apart the support portion 2, more particularly the support wall 26, by making it pivot relative to the base wall 8 in accordance with the arrow 50 (FIG. 6).

The user folds up the different sections 30 of the support wall 26 so as to confer the shape of a triangular prim thereto (arrow 52 of FIG. 7). The support wall 26 is held in this position by the cooperation of the magnet(s) 32 and of the metallic element(s) 34.

The user positions the user terminal 100 against the supporting face 20 (FIG. 8), then unfolds the pre-positioning member or frame 6 by making it pivot along the folding line 68, in accordance with the arrow 53 of FIG. 9, until bearing the pre-positioning member 6 against the front face 108 of the user terminal 100, on which the camera 102 and the screen 104 are located.

The pre-positioning member 6 is held in position against the user terminal 100 via the magnet(s) 62 or metallic element(s) 64.

The user displaces the lateral walls 42 of the reflective element 4 from the storage position to the deployed position (arrow 54 of FIG. 10), then the reflective element 4 from the storage position to the deployed position (arrow 56 of FIG. 11) until bearing the edge of the lateral walls 42 against the pre-positioning member 6. Thus, the reflective element 4 is held in position by the magnets 66. Thus, the reading device 1 is ready to be used, the user can open the visual information medium 200 to enable the reflective face 40 to reflect an image of a page of the visual information medium 200, resting on the base wall 8, in the direction of the camera 102 of the user terminal 100, said user terminal being able to display on the screen 104 a multimedia content in connection with the content of the open page of the visual information medium 200.

Of course, the invention is in no way limited to the embodiment described hereinabove, this embodiment having been given only as example. Modifications are possible, in particular with regard to the constitution of the various elements or by substitution of technical equivalents, still without departing from the scope of the invention.

1. An enhanced reading device, comprising
a support portion configured to support a user terminal having a camera, and
a reflective element configured to reflect an image of a visual information medium in a direction of the camera of the user terminal, in which
wherein the reflective element is linked to the support portion via a pre-positioning member movably mounted relative to the support portion, and
wherein the pre-positioning member configured to bear against a face of the user terminal in order to pre-position the reflective element with respect to the camera of the user terminal.

2. The enhanced reading device according to claim 1, wherein the device comprises a holding unit configured to hold the pre-positioning member bearing against the user terminal.

3. The enhanced reading device according to claim 1, wherein the support portion comprises a support wall having at least two substantially parallel folding lines dividing the support wall into several sections, so that the support wall is deformable by folding between a storage position in which the sections are substantially coplanar and a use position in which the sections form a support for the user terminal.

4. The enhanced reading device according to claim 1, wherein the reflective element is movably mounted relative to the pre-positioning member between a storage position in which the reflective element is positioned substantially parallel to the pre-positioning member and a deployed position in which the reflective element is inclined with respect to the pre-positioning member.

5. The enhanced reading device according to claim 4, wherein the reflective element comprises a central reflective face and two lateral walls movable relative to the central reflective face between a storage position in which the lateral walls and the central face are substantially parallel and a deployed position in which the lateral walls are inclined with respect to the central reflective face.

6. The enhanced reading device according to claim 4, wherein the device comprises a holding unit configured to hold the reflective element in the deployed position.

7. The enhanced reading device according to claim 1, wherein the device comprises a base wall movably mounted relative to the support portion or to the pre-positioning member, the base wall being configured to delimit with the pre-positioning member, and where appropriate the support portion, a storage volume intended to receive a visual information medium.

8. The enhanced reading device according to claim 7, wherein the base wall comprises a border delimiting an area for capturing images by the reflective element when the reflective element is in the deployed position.

9. The enhanced reading device according to claim 1, wherein the support portion, the pre-positioning member, and where appropriate the base wall, are made in one piece part.

10. An enhanced reading set comprising the enhanced reading device according to any of claim 1 and comprising the user terminal and/or the visual information medium.
